(19) United States
(12) Patent Application Publication
(10) Pub. No.: US 2019/0239452 A1
(43) Pub. Date: Aug. 8, 2019

(54) MUNICIPAL GARDEN SWEEPER

(71) Applicant: Xiaojun LIU, SHENZHEN (CN)

(72) Inventors: XIAOJUN LIU, SHENZHEN (CN); Caixia WANG, SHENZHEN (CN); Junlong LIU, SHENZHEN (CN)

(21) Appl. No.: 16/203,646

(22) Filed: Nov. 29, 2018

(30) Foreign Application Priority Data
Feb. 8, 2018 (CN) 201810127576.2

(51) Int. Cl. A01G 20/47; A47L 7/00; A47L 9/00; A47L 9/28

(52) U.S. Cl. CPC A01G 20/47; A47L 7/0061; B65F 7/00; A47L 9/2894; A47L 9/009

(57) ABSTRACT

A municipal garden sweeper includes a mobile frame, a control box arranged on an upper portion of the mobile frame, a first exhaust pipe, and a second exhaust pipe arranged on left and right sides of the control box. The first exhaust pipe and the second exhaust pipe are configured to suck up and collect external garbage. A first exhaust fan is arranged on a connecting portion of the first exhaust pipe and the control box. A second exhaust fan is arranged on a connecting portion of the second exhaust pipe and the control box. The first exhaust fan and the second exhaust fan are configured to respectively provide power for the first exhaust pipe and the second exhaust pipe to suck up the external garbage.

### BACKGROUND

### 1. Technical Field

The present disclosure relates to a field of municipal garden sweeper technology, and in particularly to a municipal garden sweeper with reasonable structure design, simple control, long service life, high intelligence degree and high garbage collection efficiency.

### 2. Description of Prior Art

With rapid urbanization and a rapid increment of streets, environmental sanitation workload is increasing, and traditional manual cleaning relying on environmental sanitation workers is time-consuming and laborious. Therefore, various sweepers have appeared on the market. Most of the sweepers are large-sized suction sweepers. These sweepers are complicated in structure, high in energy consumption and maintenance cost. Further, the size of the sweepers is large and the sweepers are not suitable for cleaning operations in public places such as streets, factories, squares, living quarters, and etc. Additionally, a small-sized sweeper is too small and not suitable for cleaning operations in public places such as streets, campus plazas and living quarters. Therefore, in order to solve the above technical problems, it is necessary to provide an innovative municipal garden sweeper to overcome defects of the prior art.

In recent years, science and technology have achieved rapid development and progress. How to effectively combine municipal garden sweeper technology with intelligent technology so as to improve work efficiency is a problem frequently considered by those skilled in the art. A lot of research, development and experiments have been carried out and a good result has been obtained.

### SUMMARY

In order to overcome the problems existing in the prior art, the present disclosure provides a municipal garden sweeper with reasonable structure design, simple control, long service life, high intelligence degree, and high garbage collection efficiency.

Compared with the prior art, the present disclosure of a municipal garden sweeper comprises a mobile frame, a control box arranged on an upper portion of the mobile frame, a first exhaust pipe arranged on a left side of the control box and a second exhaust pipe arranged on a right side of the control box. The first exhaust pipe and the second exhaust pipe are configured to suck up and collect external garbage. A first exhaust fan is arranged on a connecting portion of the first exhaust pipe and the control box. A second exhaust fan is arranged on a connecting portion of the second exhaust pipe and the control box. The first exhaust fan is configured to provide power for the first exhaust pipe to suck up the external garbage. The second exhaust fan is configured to provide power for the second exhaust pipe to suck up the external garbage. A power supply, a controller, a temperature and humidity sensor, a network communication transmission unit, an alertor, a data memory, and a garbage amount sensor are arranged in an interior of the control box. In actual operation processes, the municipal garden sweeper is able to suck up the external garbage well. Further, the structure design is reasonable, the garbage suction and cleaning are integrated design, the intelligence degree is high, and the use effect is good.

### BRIEF DESCRIPTION OF DRAWINGS

FIG. 1 is a perspective view showing a structure diagram of a municipal garden sweeper of the present disclosure;

FIG. 2 is another perspective view showing a structure diagram of the municipal garden sweeper of the present disclosure; and

FIG. 3 is a schematic diagram showing a circuit connecting structure of the municipal garden sweeper of the present disclosure.

### DETAILED DESCRIPTION

To make the objects, technical proposals and merits of the present disclosure more apparent, the present disclosure will be further described in detail with reference to the drawings and embodiments. It should be understood that the embodiments described here are only used to illustrate the present disclosure and are not intended to limit the present disclosure.

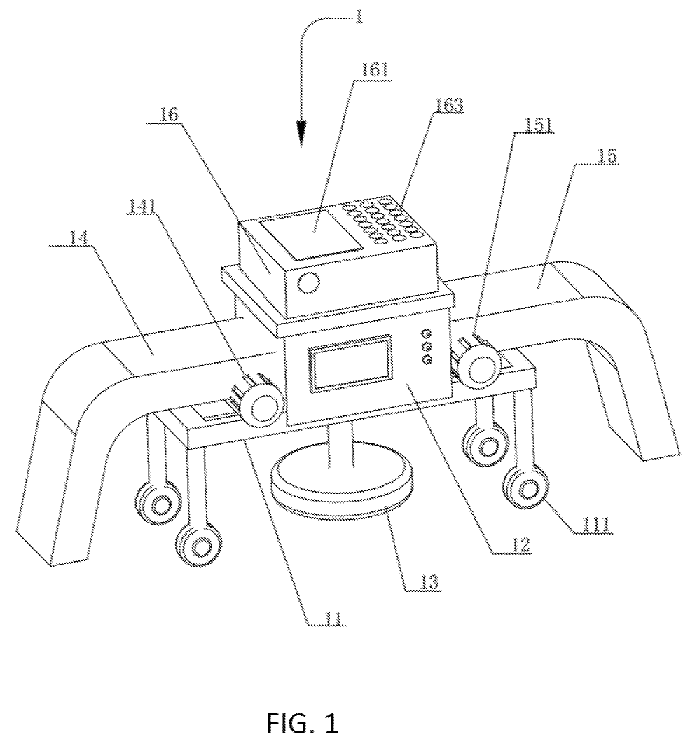

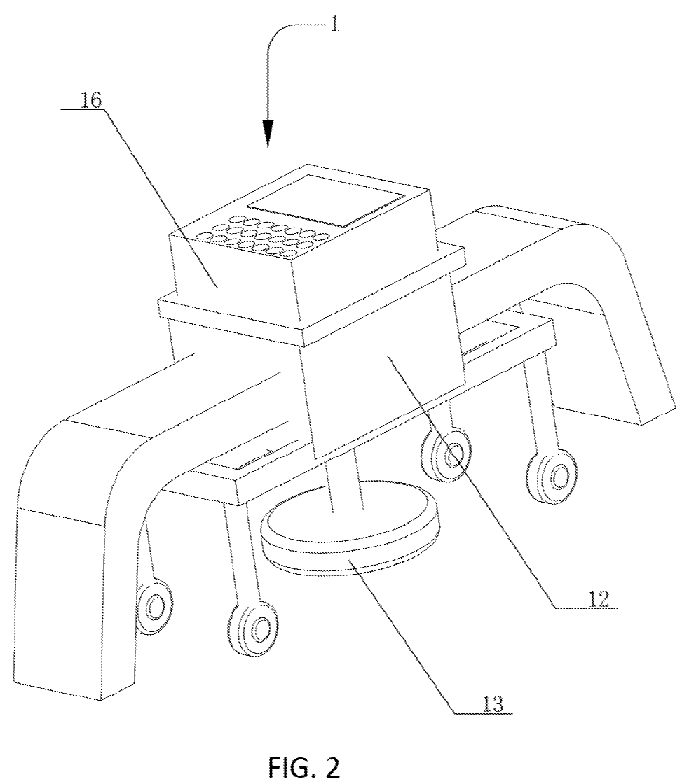

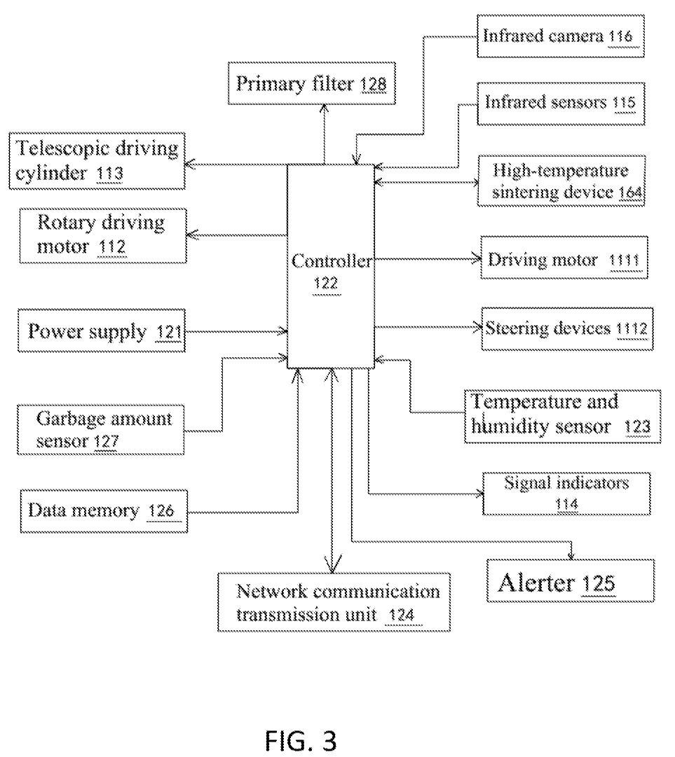

As shown in FIG. 1 to FIG. 3, the present disclosure of a municipal garden sweeper 1 comprises a mobile frame 11, a control box 12 arranged on an upper portion of the mobile frame 11, a first exhaust pipe 14 arranged on a left side of the control box 12, and a second exhaust pipe 15 arranged on a right side of the control box 12. The first exhaust pipe 14 and the second exhaust pipe 15 are configured to suck up and collect external garbage. A first exhaust fan 141 is arranged on a connecting portion of the first exhaust pipe 14 and the control box 12. A second exhaust fan 151 is arranged on a connecting portion of the second exhaust pipe 15 and the control box 12. The first exhaust fan 141 is configured to provide power for the first exhaust pipe 14 to suck up the external garbage. The second exhaust fan 151 is configured to provide power for the second exhaust pipe 15 to suck up the external garbage. A power supply 121, a controller 122, a temperature and humidity sensor 123, a network communication transmission unit 124, an alertor 125, a data memory 126, and a garbage amount sensor 127 are arranged in an interior of the control box 12. The temperature and humidity sensor 123, the network communication unit 124, the alertor 125, the data memory 126, the garbage amount sensor 127, the first exhaust fan 141, and the second exhaust fan 151 are electrically connected with the controller 122;

A roller 111 is arranged on any of four diagonal positions of a bottom portion of the mobile frame 11. A driving motor 1111 is arranged on any one of the roller 111. Steering devices 1112 are respectively arranged on the two rollers 111 arranged on a front portion of the mobile frame 11. The driving motor 1111 and the steering devices 1112 are electrically connected with the controller 122. A garbage high-temperature treatment box 16 is arranged on an upper portion of the control box 12. A lower portion of the garbage high temperature treatment box 16 is communicated with the control box 12. A high-temperature sintering device 164 configured to perform high-temperature sintering treatment on the garbage is arranged in an interior of the garbage high-temperature treatment box 16. A plurality of exhaust ports 163 and a cleaning bin door 161 are arranged on an upper portion of the garbage high-temperature treatment box 16. The exhaust ports 163 are configured to exhaust waste gas, and the cleaning bin door 161 is configured to clean the garbage inside the garbage high temperature treatment box 16. The high-temperature sintering device 164 is electrically connected with the controller 122.

A sweeping mechanism assembly 13 connected with the mobile frame 11 is arranged on a bottom portion of the control box 12. The sweeping mechanism assembly 13 comprises a connecting rod and a rotary cleaning machine fixedly connected with an end of the connecting rod. The rotary cleaning machine is wrapped with a cleaning flannelette blanket outside. A rotary drive motor is arranged on the bottom portion of the mobile frame 11. The rotary drive motor is movably coupled to an other end of the connecting rod relative to the rotary cleaning machine. The rotary drive motor is configured to drive the connecting rod and the rotary cleaning machine to rotate together. The connecting rod is further connected with a telescopic rod. A telescopic driving cylinder 113 is arranged inside the connecting rod to drive the telescopic rod to stretch out and draw back. An end of the telescopic rod is connected with the rotary cleaning machine. The rotary driving motor 112 and the telescopic driving cylinder 113 are electrically connected with the controller 122. A water storage box is connected to the bottom portion of the mobile frame 11, and the water storage box extending into a portion of the rotary cleaning machine through a pipeline. When the rotary cleaning machine rotates and operates, water is supplied to the cleaning flannelette blanket through the pipeline to keep the cleaning flannelette blanket wet.

A plurality of infrared sensors 115 are arranged on a periphery of the mobile frame 11. An infrared camera 116 is arranged on an end head portion of a front end of the mobile frame 11. The infrared sensors 115 and the infrared camera 116 are electrically connected with the controller 122. The first exhaust pipe 14 and the second exhaust pipe 15 are integrally arranged in a v-type. A rectangular an outlet is arranged in an opening position of each first exhaust pipe 14 and each second exhaust pipe 15. A isolation net configured to avoid ingestion of large-block materials is arranged on each rectangular air outlet of the first exhaust pipe 14 and the second exhaust pipe 15. A primary filter 128 is arranged in the interior of the control box 12 and the primary filter 128 is electrically connected with the controller 122.

The present disclosure of the municipal garden sweeper 1 with high garbage collection efficiency comprises the mobile frame 11, the control box 12 arranged on the upper portion of the mobile frame 11, the first exhaust pipe 14 arranged on the left side of the control box 12, and the second exhaust pipe 15 arranged on the right side of the control box 12. The first exhaust pipe 14 and the second exhaust pipe 15 are configured to suck up and collect external garbage. The first exhaust fan 141 is arranged on the connecting portion of the first exhaust pipe 14 and the control box 12. The second exhaust fan 151 is arranged on the connecting portion of the second exhaust pipe 15 and the control box 12. The first exhaust fan 141 is configured to provide power for the first exhaust pipe 14 to suck up the external garbage. The second exhaust fan 151 is configured to provide power for the second exhaust pipe 15 to suck up the external garbage. The power supply 121, the controller 122, the temperature and humidity sensor 123, the network communication transmission unit 124, the alertor 125, the data memory 126, and the garbage amount sensor 127 are arranged in the interior of the control box 12. In actual operation processes, the municipal garden sweeper 1 is able to suck up the external garbage well. Furthermore, the structure design is reasonable, the garbage suction and cleaning are integrated design, the intelligence degree is, high, and the use effect is good.

Furthermore, each roller 111 of the mobile frame 11 is connected with a supporting rod. A height adjusting mechanism is arranged on a connecting portion of the supporting rod and the roller 111 to adjust a height of the roller 111. The height adjusting mechanism is electrically connected with the controller 122.

Furthermore, ultraviolet (UV) disinfection lamps are installed in the interior portion of the control box 12 and the interior portion of the garbage high temperature treatment box 16.

Furthermore, a BLUETOOTH transmission unit electrically connected with the controller 122 is arranged in the interior portion of the control box 12.

Furthermore, a plurality of signal indicators 114 are arranged on an outer periphery of the mobile frame 11.

Furthermore, the exhaust port arranged on the upper portion of the garbage high-temperature treatment box 16 ranges from 5-20 cm in diameter.

Compared with the prior art, the present disclosure of the municipal garden sweeper 1 with high garbage collection efficiency comprises the mobile frame 11, the control box 12 arranged on the upper portion of the mobile frame 11, the first exhaust pipe 14 arranged on the left side of the control box 12, and the second exhaust pipe 15 arranged on the right side of the control box 12. The first exhaust pipe 14 and the second exhaust pipe 15 are configured to suck up and collect external garbage. The first exhaust fan 141 is arranged on the connecting portion of the first exhaust pipe 14 and the control box 12. The second exhaust fan 151 is arranged on the connecting portion of the second exhaust pipe 15 and the control box 12. The first exhaust fan 141 is configured to provide power for the first exhaust pipe 14 to suck up the external garbage. The second exhaust fan 151 is configured to provide power for the second exhaust pipe 15 to suck up the external garbage. The power supply 121, the controller 122, the temperature and humidity sensor 123, the network communication transmission unit 124, the alertor 125, the data memory 126, and the garbage amount sensor 127 are arranged in the interior of the control box 12. In actual operation processes, the municipal garden sweeper 1 is able to suck up the external garbage well. Furthermore, the structure design is reasonable, the garbage suction and cleaning are integrated design, the intelligence degree is high, and the use effect is good.

The above-described embodiments of the present disclosure are not to be construed as limiting the scope of the present disclosure. Any of the modifications, equivalent replacement, and improvement within the spirit and principle of the present disclosure should fall within the protection scope of the claim.

What is claimed is:

1. A municipal garden sweeper, comprising:
a mobile frame;
a control box arranged on an upper portion of the mobile frame;
a first exhaust pipe arranged on a left side of the control box; and
a second exhaust pipe arranged on a right side of the control box;
wherein the first exhaust pipe and the second exhaust pipe are configured to suck up and collect external garbage; a first exhaust fan is arranged on a connecting portion of the first exhaust pipe and the control box; a second exhaust fan is arranged on a connecting portion of the second exhaust pipe and the control box; the first exhaust fan is configured to provide power for the first exhaust pipe to suck up the external garbage; the second exhaust fan is configured to provide power for the second exhaust pipe to suck up the external garbage;
wherein a power supply, a controller, a temperature and humidity sensor, a network communication transmission unit, an alertor, a data memory, and a garbage amount sensor are arranged in an interior of the control box; the temperature and humidity sensor, the network communication unit, the alertor, the data memory, the garbage amount sensor, the first exhaust fan, and the second exhaust fan are electrically connected with the controller;
wherein a roller is arranged on any of four diagonal positions of a bottom portion of the mobile frame; a driving motor is arranged on any one of the roller; and steering devices are respectively arranged on two roller portions arranged on a front portion of the mobile frame; the driving motor and the steering devices are electrically connected with the controller; and a garbage high-temperature treatment box is arranged on an upper portion of the control box; a lower portion of the garbage high temperature treatment box is communicated with the control box; a high-temperature: sintering device configured to perform high-temperature sintering treatment on the garbage is arranged in an interior of the garbage high-temperature treatment box; a plurality of exhaust ports and a cleaning bin door are arranged on an upper portion of the garbage high-temperature treatment box; the exhaust ports are configured to exhaust waste gas and the cleaning bin door is configured to clean the garbage inside the garbage high temperature treatment box; the high-temperature sintering device is electrically connected with the controller;
wherein a sweeping mechanism assembly connected with the mobile frame is arranged on a bottom portion of the control box; the sweeping mechanism assembly comprises a connecting rod and a rotary cleaning machine fixedly connected with an end of the connecting rod; the rotary cleaning machine is wrapped with a cleaning flannelette blanket outside; a rotary drive motor is arranged on the bottom portion of the mobile frame; the rotary drive motor is movably coupled to an other end of the connecting rod relative to the rotary cleaning machine; and the rotary drive motor is configured to drive the connecting rod and the rotary cleaning machine to rotate together; the connecting rod is further connected with a telescopic rod; and a telescopic driving cylinder is arranged inside the connecting rod to drive the telescopic rod to stretch out and draw back; an end of the telescopic rod is connected with the rotary cleaning machine; the rotary driving motor and the telescopic driving cylinder are electrically connected with the controller; a water storage box is connected to the bottom portion of the mobile frame, and the water storage box extending into a portion of the rotary cleaning machine through a pipeline; when the rotary cleaning machine rotates and operates, water is supplied to the cleaning flannelette blanket through the pipeline to keep the cleaning flannelette blanket wet;
wherein a plurality of infrared sensors are arranged on a periphery of the mobile frame; an infrared camera is arranged on an end head portion of a front end of the mobile frame; the infrared sensors and the infrared camera are electrically connected with the controller; the first exhaust pipe and the second exhaust pipe are integrally arranged in a v-type; and a rectangular air outlet is arranged in an opening position of each first exhaust pipe and each second exhaust pipe; a isolation net configured to avoid ingestion of large-block materials is arranged on each rectangular air outlet of the first exhaust pipe and the second exhaust pipe; a primary filter is arranged in the interior of the control box; the primary filter is electrically connected with the controller.

2. The municipal garden sweeper according to claim 1, wherein each roller of the mobile frame is connected with a supporting rod; and a height adjusting mechanism is arranged on a connecting portion of the supporting rod and the roller to adjust a height of the roller; and the height adjusting mechanism is electrically connected with the controller.

3. The municipal garden sweeper according to claim 1, wherein ultraviolet (UV) disinfection lamp is installed in the interior portion of the control box and the interior portion of the garbage high temperature treatment box.

4. The municipal garden sweeper according to claim 1, wherein a BLUETOOTH transmission unit electrically connected with the controller is arranged in the interior portion of the control box.

5. The municipal garden sweeper according to claim 1, wherein a plurality of signal indicators are arranged on an outer periphery of the mobile frame.

6. The municipal garden sweeper according to claim 1, wherein the exhaust port arranged on the upper portion of the garbage high-temperature treatment box ranges from 5-20 cm its diameter.
